(19) United States
(12) Patent Application Publication
(10) Pub. No.: US 2023/0399891 A1
(43) Pub. Date: Dec. 14, 2023

(54) BLIND SLAT POSITIONING DEVICE AND A WINDOW BLIND THEREOF

(71) Applicants: Hsien-Te HUANG, Taipei City (TW); Yu-Wei HUANG, Taipei City (TW)

(72) Inventors: Hsien-Te HUANG, Taipei City (TW); Yu-Wei HUANG, Taipei City (TW)

(21) Appl. No.: 17/840,133

(22) Filed: Jun. 14, 2022

(51) Int. Cl. E06B 9/324; E06B 9/322

(52) U.S. Cl. CPC E06B 9/324; E06B 9/322; E06B 2009/3222

(57) ABSTRACT

The present invention discloses a blind slat positioning device and a window blind thereof. The positioning device can fix the slat at any height at which the slat is pulled down. The positioning device includes a turning seat which is provided at least with an overbend element for a pull cord to wrap around. The overbend element includes at least a ridge, resulting an effect that the slat stops at the height at which the slat is pulled down, with the aid of gravity.

### BACKGROUND OF THE INVENTION

### (A) Field of the Invention

The present invention relates to a blind slat positioning device and a window blind thereof, and more particularly to a blind slat positioning device which provides for a window blind without an external pull cord, so that the slats can be fixed at any height upon being pulled down.

### (b) Description of the Prior Art

For a window blind with horizontal slats being pulled up and down manually, a side of the blind is exposed outward with a pull cord to operate the slats manually. However, the pull cord can cause danger to an innocent child when he or she is playing the window blind. Therefore, to ensure and maintain the safety of use of the window blind, a window blind without the external pull cord has been developed. The existing window blind without the external pull cord usually includes a release mechanism and two dampers. Each damper is disposed at a side of the release mechanism and is provided with a turning seat. The turning seat usually includes at least a shaft. The inner pull cord wraps around the shaft of the turning seat, penetrates the slat downward, and is then fixed at a bottom rail of the window blind. By the friction force between the inner pull cord and the dampers, the slat can be prevented from sliding downward by a natural external force or gravity itself.

The existing shaft is a metal rod. Two ends of the metal rod are normally fixed at two side grooves of the turning seat by a tight-fitting method. As the shaft has a circular cross section, it is hard to be fixed radially. After being used for a long time, the metal rod can be slipping to roll, and this condition will cause the dampers to lose the damping effect due to the rolling of shaft.

### SUMMARY OF THE INVENTION

A primary object of the present invention is to provide a blind slat positioning device, wherein two sides of a top rail are implemented respectively with at least an overbend element for a pull cord to change direction and overbend downward, and a longitudinal surface of the overbend element for the thread of pull cord to climb over is longitudinally provided at least with a ridge. The stress direction of an overbend section of the pull cord is changed by the ridge, which results in damping to the pull cord, and fixes the slat at a height indirectly when the slat is not moving.

A second object of the present invention is to provide a blind slat positioning device, wherein the cross section of the ridge provided by the overbend element is in a shape of triangle, rhomboid, T, cross, square, U, or equiangular polygon. In addition, the curvature or included angle of the ridge can vary, and a front and rear end of the overbend element can be fixed directly or indirectly on two sides of the top rail.

A third object of the present invention is to provide a blind slat positioning device, wherein the overbend element is assembled on a turning seat, and the turning seat includes a base plate and a pair of side wall. Each side wall is disposed on a side of the base plate and is formed at least with an embedding part. As the cross section of overbend element is provided with the ridge and therefore is not a true circle, two ends of the overbend element are fixed by the embedding parts three-dimensionally.

A fourth object of the present invention is to provide a window blind, including a top rail, a bottom rail, a slat, a release mechanism, and two positioning devices. The release mechanism links the pull cord, and each positioning device includes a turning seat and at least an overbend element. The cross section of the overbend element is not a circle, and the pull cord wraps around the surface of overbend element.

For the blind slat positioning device disclosed by the present invention, the cross section of overbend element can by any geometry other than a true circle, which can prevent the overbend element from sliding and rolling. Furthermore, the provided ridge can allow the thread of pull cord that passes through the overbend element tangentially to bend, resulting in a change in direction of the stress. In addition, by combining with a pull force to the pull cord due to gravity of the slat, a shear force is formed to the ridge, which achieves the damping effect.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a schematic view of assembly where a positioning device is implemented to a window blind, according to the present invention.

FIG. 2 shows a three-dimensional view of application of an overbend element, according to the present invention.

FIG. 3 shows a side view of application of the overbend element, according to the present invention.

FIG. 4 shows another side view of implementation of the overbend element, according to the present invention.

FIG. 5 shows a schematic view of implementation of a change in position of the overbend element in FIG. 4, according to the present invention.

FIG. 6 shows another side view of implementation of a change in position of the overbend element, according to the present invention.

FIG. 7 shows a side view of implementation of a change in position of the overbend element in FIG. 6, according to the present invention.

FIG. 8 shows another side view of implementation of a change in position of the overbend element in FIG. 6, according to the present invention.

FIG. 9 shows another side view of implementation of the overbend element, according to the present invention.

FIG. 10 shows still another side view of implementation of the overbend element, according to the present invention.

FIG. 11 shows a local schematic view of a window blind, according to the present invention.

FIG. 12 shows a three-dimensional exploded view of assembly of positioning device, according to the present invention.

FIG. 13 shows a top view of assembly of the positioning device, according to the present invention

FIG. 14 shows a cutaway view along the line IV-IV in FIG. 13.

FIG. 15 shows a cutaway view of another wiring method of the positioning device, according to another embodiment of the present invention.

FIG. 16 shows a cutaway view of the positioning device, according to a second embodiment of the present invention.

FIG. 17 shows a cutaway view of another wiring method of the positioning device, according to a third embodiment of the present invention.

FIG. 18 shows a cutaway view of the positioning device, according to a fourth embodiment of the present invention.

FIG. 19 shows a cutaway view of another wiring method of the positioning device, according to a fifth embodiment of the present invention.

FIG. 20 shows a cutaway view of the positioning device, according to a sixth embodiment of the present invention.

FIG. 21 shows a cutaway view of another wiring method of the positioning device, according to a seventh embodiment of the present invention.

### DETAILED DESCRIPTION OF THE PREFERRED EMBODIMENTS

The present invention discloses a blind slat positioning device. The positioning device is used for a window blind wherein a horizontal slat is pulled up and down by feedback of elastic energy. By the positioning device, a pull cord which passes through the positioning device can be damped when the pull cord is not moving, which fixes a lower end of the slat at any height indirectly. The positioning device is provided with a turning seat for the pull cord to pass through, the turning seat is provided at least with an overbend element in a shape of long rod for the pull cord to climb over and change direction, and two ends of the overbend element can be fixed at a three-dimensional angle. A longitudinal surface of the rod is provided at least with a ridge to result in a tangential damping to the thread of pull cord that climbs over the ridge.

The ridge is disposed on a center in the arc length of the overbend section of the pull cord; or, there can be more than two ridges, disposing at equal angles in the overbend arc angle. A tip of the ridge is a blunt angle or an arc. For more than two ridges, the curvature or the blunt angle can vary.

The total cross section of the overbend element can be in a shape of triangle, rhomboid, T, cross, square, U, capsule formed by combining two U-shaped units back-to-back, or polygon.

The turning seat is provided with a base plate, a bottom of the turning seat is transfixed with a downward perforation for the pull cord to pass through, and two sides of the turning seat are provided upward with an embedding part for combining with the overbend element respectively, with one embedding part opposite to each other.

There are three embedding parts distributed at corners of a virtual triangular region, and that triangle is put on the base plate upside-down. In addition, the triangle further includes an isosceles triangle, and the vertex is disposed in the middle upside-down.

The detailed implementation and functions of operation are described hereinafter, in reference to the drawings.

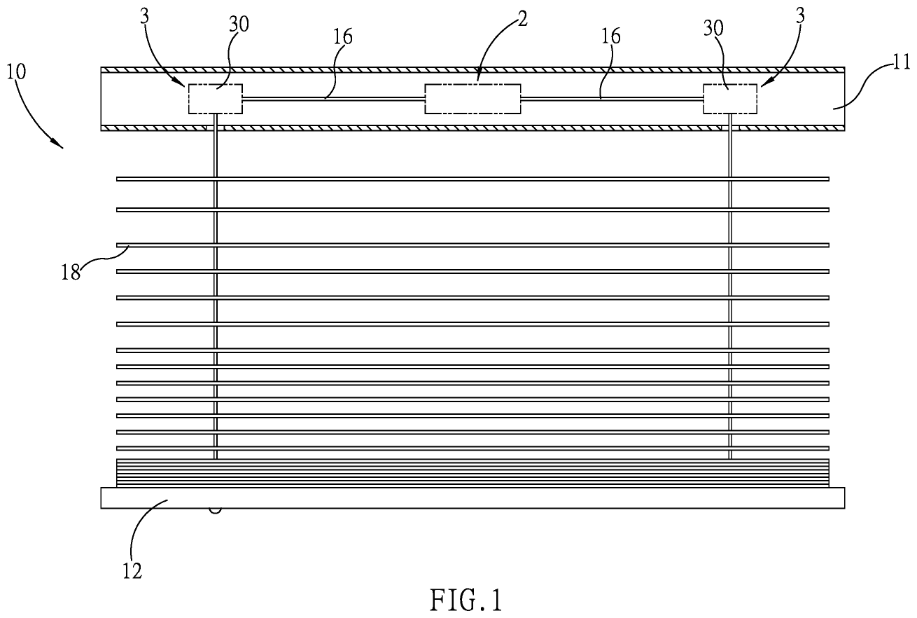

Referring to FIG. 1, in a window blind 10, a pull cord 16 driven by a release mechanism 2 is turned via two sides of a top rail 11, and is combined downward with and links a slat 18. Two free ends of the pull cord 16 are combined at a bottom rail 12. A change of light shielding area of the slat 18 between the bottom rail 12 and the top rail 11 is determined by the pull-down length of the pull cord 16. To operate the pull-down height of the slat 18, a user utilizes his or her fingers to pull a rod body of the bottom rail 12 to change the stroke of height of the slat 18, wherein the pull cord 16 is turned via a turning seat 30 and stops. The turning seat 30 is implemented in the present invention as a positioning device 3, and the change in stress to the thread of pull cord 16 that wraps around is performed by the positioning device 3, so that the slat 18 can be damped when it is not moving after being pulled down, thereby achieving the positioning effect to a lower end of the slat 18.

Referring to FIG. 2, the positioning device 3 in the present invention includes at least an overbend element 300 which can be fixed three-dimensionally. The overbend element 300 is positioned on a base plate 31 provided by the turning seat 30, and its longitudinal line S is horizontal and perpendicular to a running direction of the pull cord 16. The pull cord 16 is turned via the overbend element 300 and passes through a downward perforation 310 provided by the base plate 31.

The overbend element 300 includes a long rod body 301, providing an overbend surface for the pull cord 16 to wrap around. The overbend surface is provided at least with a ridge 302 which is parallel to the longitudinal line S. The ridge 302 enables the pull cord 16 to result in a change in stress when the thread of pull cord 16 passes through the ridge 302 tangentially, thereby forming a damping function. In addition, according to the direction at which the pull cord 16 wraps around, e.g., overbending by 90° to larger than 180°, the surface of rod body 301 providing a loop surface for the thread to wrap around is provided symmetrically from top to bottom with plural ridges 302 that are parallel to the longitudinal line S.

The damping and friction action between the abovementioned ridge 302 and the pull cord 16 comes from the pull cord 16 itself, which is formed by twisting plural fibers. The thread is kneaded to form gaps, allowing the thread to be deformed by an external force. When the thread overbends by the external force, the cross section of a thread section that climbs over and shears on the ridge 302 will be changed by the shear of external force, and the direction of stress caused by the deformation will act upon two sides of the ridge 302. Primarily on a side on a running direction of the pull cord 16 when it is being pulled, the resulted deformation stress will act onto a core of the ridge 302 (longitudinal line S), forming friction of deformation. An effective damping is resulted from that friction to stop the movement of pull cord 16.

The ridge 302 that is formed easily by the overbend element 300 is a tiny structure, but it can acquire much more capability to stop the pull cord 16 than a prior art.

The cross section of ridge 302 can be in a shape of arc and is combined on an outer surface of the rod body 301 to provide longitudinally a sliding surface to the pull cord 16. The ridge 302 is metallic and is formed integrally with the rod body 301; the ridge 302 can be in a shape of arc or blunt angle.

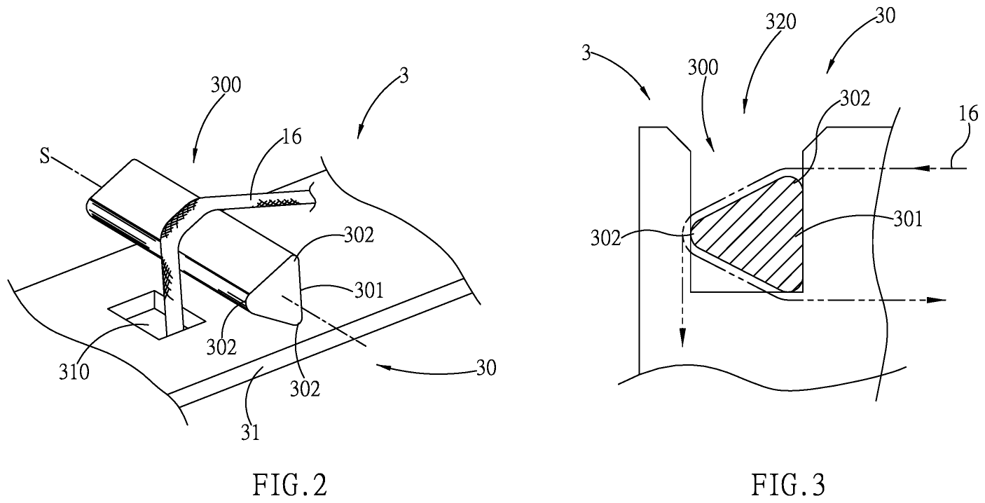

Referring to FIG. 3, the rod body 301 has a triangular cross section, and corners are provided respectively with the ridge 302. The ridges 302 are fixed at the embedding part 320 provided by the turning seat 30. The embedding part 320 is a U-shaped cut gap, and its width is equal to the height of triangle of the overbend element 300. The pull cord 16 wraps around the overbend element 300 from the entrance of turning seat 30; and depending upon the wrapping angle of the pull cord 16, at least two out of three ridges 302 can be touched. For example, if the pull cord 16 bends by 90°, a shear function can be obtained for two ridges 302; or, if the pull cord 16 wraps by 180°, the shear function can be obtained for three ridges 302.

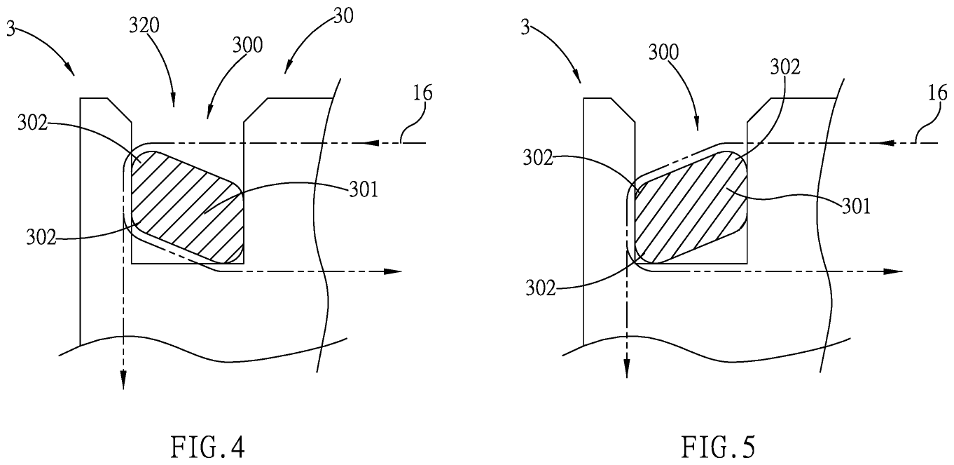

Referring to FIG. 4 and FIG. 5, the overbend element 300 in the present invention can be fixed at the embedding part 320 of the turning seat 30. The embedding part 320 can have a rhomboidal cross section, forming arc-shaped ridges 302 at various included angles. The curvatures of ridges 302 can also vary according to the change in included angles.

The cross section of the embedding part 320 is in a shape of rhomboid. Therefore, under a condition that the pull cord 16 wraps around by 90°, the ridge 302 at an upper end will act as a shear function. Or, if the pull cord 16 wraps by an angle larger than 90°, the ridge 302 in a different curvature will squeeze the pull cord 16. On the other hand, if the pull cord 16 wraps by 180°, three ridges 302 will squeeze the thread of pull cord 16 that wraps around.

The rhomboid includes opposite parallel edges, and can fit with the embedding part 320 for fixation and combination. In addition, the rhomboid can be used interchangeably at various angles, as shown in FIG. 4 and FIG. 5.

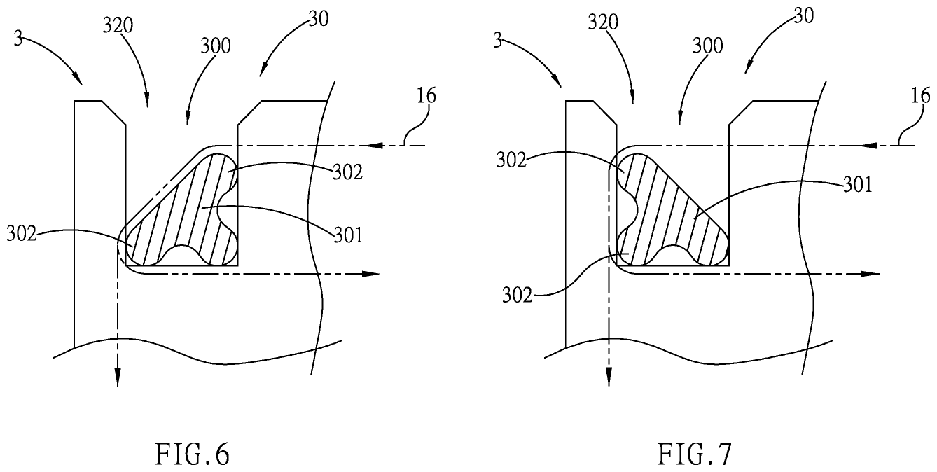

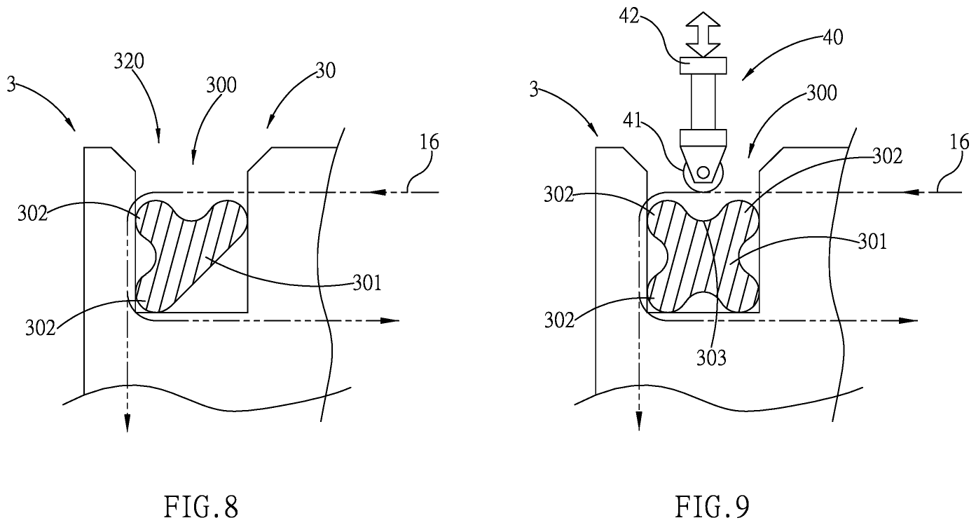

Referring to FIG. 6, FIG. 7, and FIG. 8, the overbend element 300 is disposed at the embedding part 320 of the turning seat 30. The overbend element 300 has a T-shaped cross section, and end parts of T are formed respectively with the ridge 302. The rod body 301 with the T-shaped cross section can be combined with the embedding part 320 at various angles as shown in FIGS. 6 to 8. Therefore, when the wrapping pull cord 16 overbends by 90° or by larger than 180°, various shear forces will be formed by the ridges 302 at different locations, which results in various damping effects.

Referring to FIG. 9, an outer surface of the rod body 301 is provided with plural ridges 302. The ridges 302 can be an equiangular cross, and a concaved notch 303 is disposed between two neighboring ridges 302. For a thread of the pull cord 16 opposite to the notch 303, a height of support wheel 41 opposite to the notch 303 can be modulated by an external modulation mechanism 40 through a modulation unit 42, so as to shear at various depth to the thread of pull cord 16. The change in depth of the shear will cause a friction force to the thread relative to the ridges 302 at two sides, forming a forced effect of external pressure. By the implementation of modulation mechanism 40, the present invention can be used in a heavy-load slat.

The rod body 301 can be in any shape of cross section, such as the T-shaped rod body 301 having the notch as described above, or the cross-shaped rod body 301; the modulation mechanism 40 can be implemented to all formed notches 303.

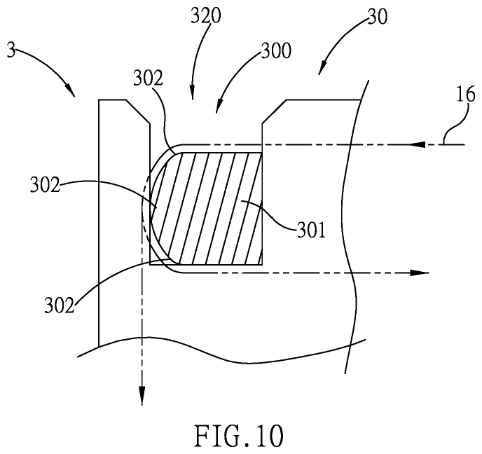

Referring to FIG. 10, the overbend element 300 implemented by the positioning device 3 is positioned at the embedding part 320 of the turning seat 30, providing for the pull cord 16 to change direction and to climb over. The rod body 301 can have a U-shaped cross section, the center thereof is provided with the ridge 302 in the smallest curvature, and the upper and lower ridges 302 are symmetric, providing for the pull cord 16 to wrap around by 90°. The pull cord 16 first shears the ridges 302 in the larger curvatures on the overbend surface, followed by the ridge 302 in the smallest curvature. If the pull cord 16 overbends by larger than 90°, the damping function can be formed to the upper, middle, and lower ridges 302. The abovementioned U-shaped overbend element 300 can be applied to a light slat, which increases the lifetime of use to the pull cord 16 and prevents the noise from a large change in the thread of pull cord 16.

In the following drawings, the said overbend elements are denoted by numbers 33, 33c, 34, 34a, 34b, 34c, 35, 35a, 35b, 35c, which are generally the subdivided numbers of the overbend element 300.

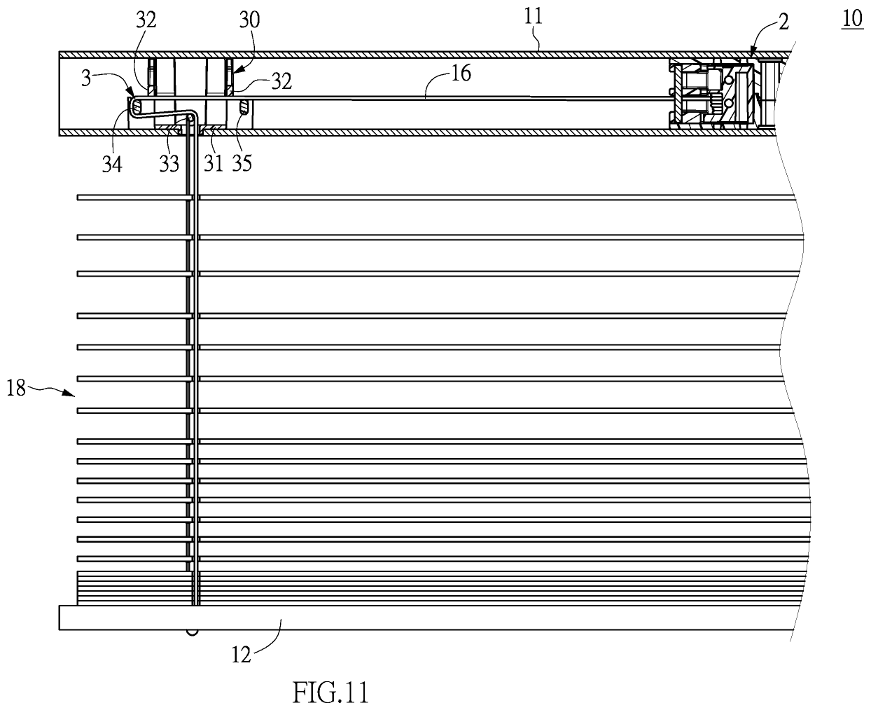

Referring to FIG. 11, the present embodiment provides a kind of positioning device 3 which can be applied to a window blind 10. The window blind 10 includes a top rail 11, a bottom rail 12, a pull cord 16, plural slats 18, a release mechanism 2, and two positioning devices 3, with each one being constituted by a turning seat 30. The release mechanism 2 and the two positioning devices 3 can be disposed inside the top rail 11. The release mechanism 2 provides power to drive the pull cord 16 to pull up and down the slats 18. Two positioning devices 3 (the right positioning device is omitted in the drawing) are disposed respectively at each side of the release mechanism 2, providing the pull cord 16 to wrap around and resulting in a resistant force.

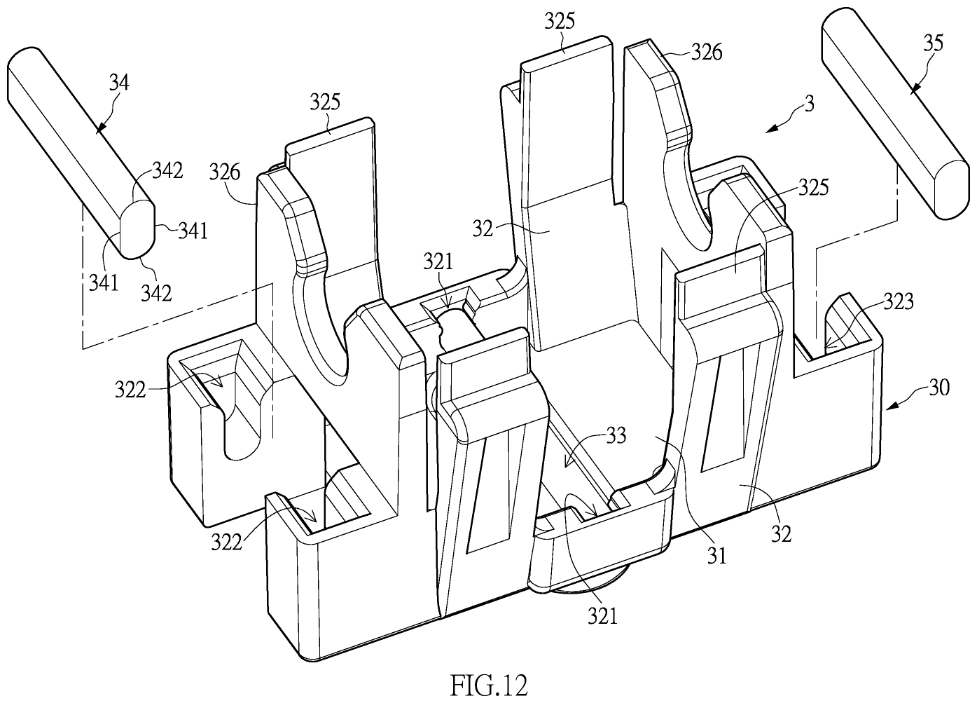

Referring to FIGS. 12 to 14, each positioning device 3 includes a turning seat 30, and an overbend element practically. There are three overbend elements 33, 34, 35, including a middle overbend element 33, a first side overbend element 34, and a second side overbend element 35, respectively. The three overbend elements 33, 34, 35 are fixed at the turning seats 30.

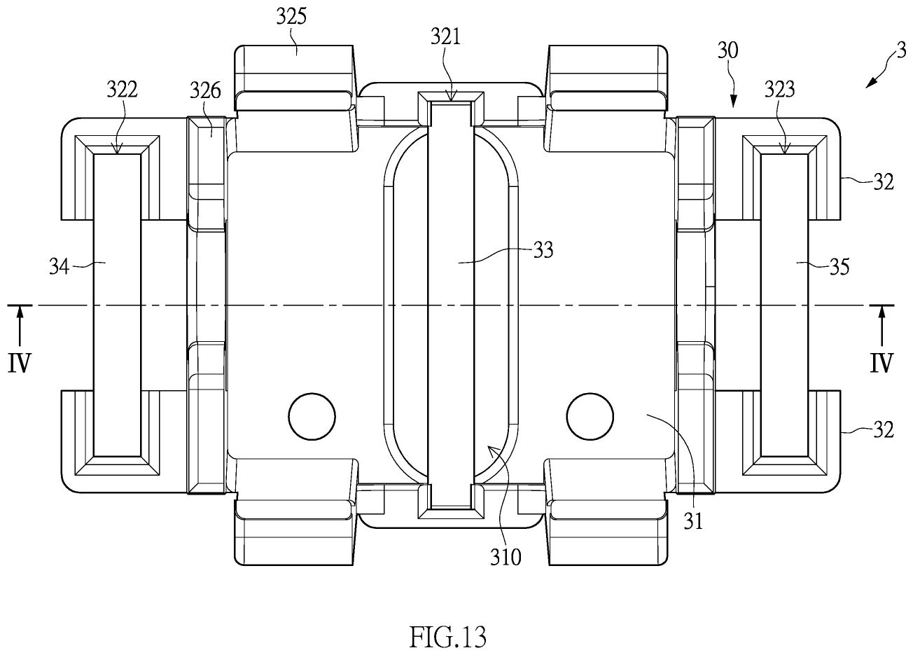

Referring to FIG. 12 and FIG. 13, the turning seat 30 includes a base plate 31, two sides of the base plate 31 are provided respectively with a side wall 32, each side wall 32 is extended with an elastic snap board 325 toward a direction away from the base plate 31, and the elastic snap board 325 can be fixed on the top rail 11. Each side wall 32 is formed with three embedding parts 321, 322, 323, with each one containing an end part of the overbend element 33, 34, 35. The embedding part fits with the overbend element and there can be at least one embedding part. A pair of vertical wall 326 is used to accommodate a beam (not shown in the drawings) which adjusts the angle of slat 18.

Each side wall 32 is formed with three embedding parts 321, 322, 323, with each one being put into an upside-down triangle. The middle embedding part 321 is closest to the base plate 31, and the overbend elements are a middle overbend element 33, a first side overbend element 34, and a second side overbend element 35. The first side overbend element 34 and the second side overbend element 35 are disposed at each side of the middle overbend element 33, and are higher than the middle overbend element 33. A center of the base plate 31 is formed with a downward perforation 310 which corresponds to the middle overbend element 33.

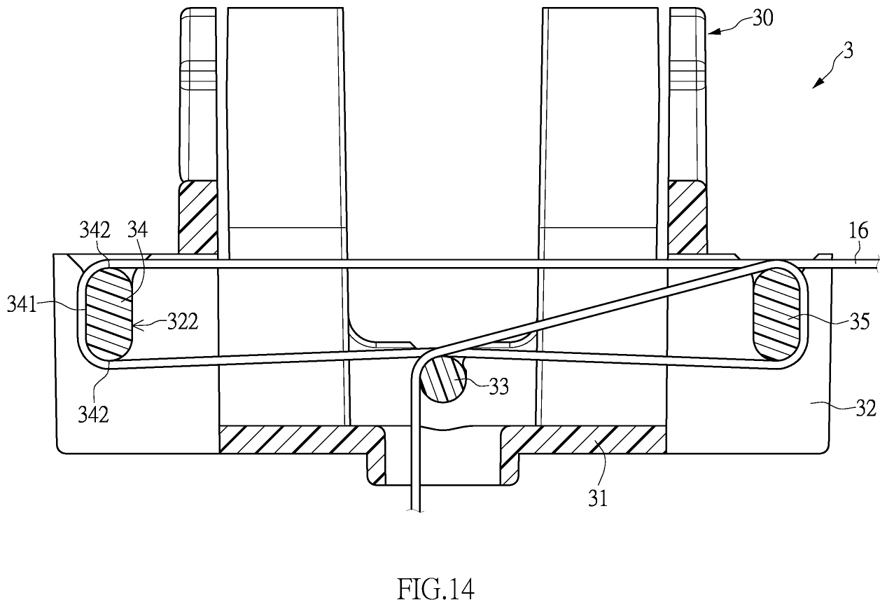

Referring to FIG. 12 and FIG. 14, one feature of the present invention lies in that at least one overbend element has a noncircular cross section (the shape of this cross section is equivalent to the U-shaped cross section in FIG. 10, forming the overbend elements 34, 35 by combining two U-shaped units back-to-back). The cross section includes opposite parallel sides, allowing the overbend element to be stably locked and fixed in the embedding part of the side wall 32, which can prevent the overbend element from rotating radially and facilitate combining with two side planes of the groove provided by the embedding part 322, with that two sides of the embedding parts 322, 323 can be planes.

The cross section of the first side overbend element 34 is in a shape of capsule assembled by two U-shaped units. Specifically, the first side overbend element 34 is provided with a pair of parallel straight edges 341, and a pair of arc edges 342 (i.e., the ridges 302 in a smaller curvature, as shown in FIG. 10). The arc edges 342 are connected at end parts of the straight edges 341, forming another ridge. Therefore, three ridges are formed at the overbend locations. However, in the present invention, the cross section of the first side overbend element is not limited to a shape of capsule, and can be also in other shape. The cross section of the second side overbend element or middle overbend element can be noncircular, as well.

Hereinafter the wiring method that the overbend element provides for the pull cord 16 to wrap around, overbend and change direction is described.

Referring to FIG. 14, the release mechanism (not shown in the drawing) is disposed on the right side of the positioning device 3. The pull cord 16 first passes through an upper entrance of the second side overbend element 35 of the positioning device 3, and then turns back by 180° from top to bottom and wraps around the first side overbend element 34. Next, the pull cord 16 wraps around the second side overbend element 35 again, and turns back by 180° from bottom to top and wraps around the second side overbend element 35, followed by returning to the middle overbend element 33 to bend downward.

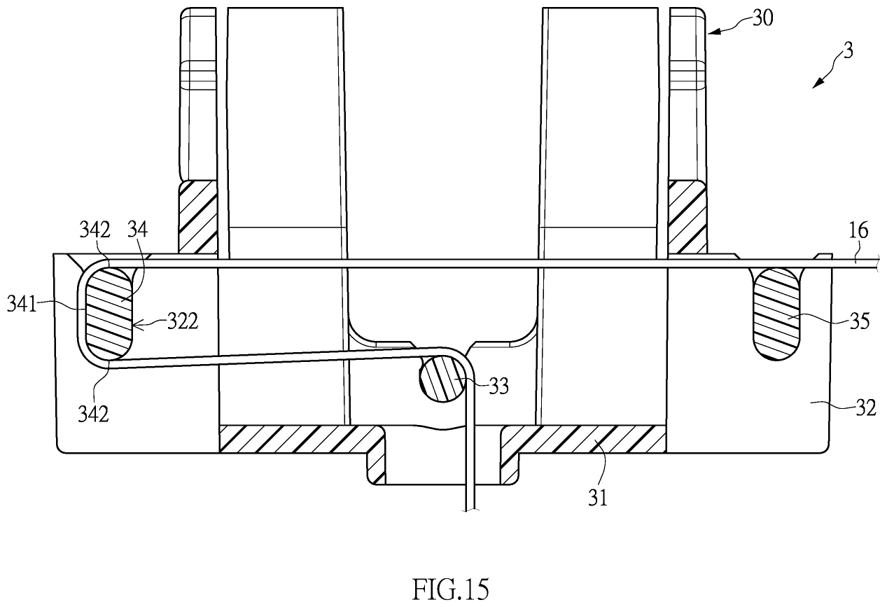

Referring to FIG. 15, three overbend elements are the same as the implemented structures as that in FIG. 14, with the only difference being the wiring method. The pull cord 16 first passes through an upper side of the second side overbend element 35 of the positioning device 3, and then turns back by 180° from top to bottom and wraps around the first side overbend element 34. Next, the pull cord 16 wraps around the middle overbend element 33 again, and turns back by 90° from top to bottom to wrap around the middle overbend element 33, and penetrates the slat 18 (not shown in the drawing) downward. Under the condition where the middle overbend element 33 only provides for overbending and pulling down the pull cord 16, the cross section of the middle overbend element 33 can be in a shape of circle, or the middle overbend element 33 can rotate radially.

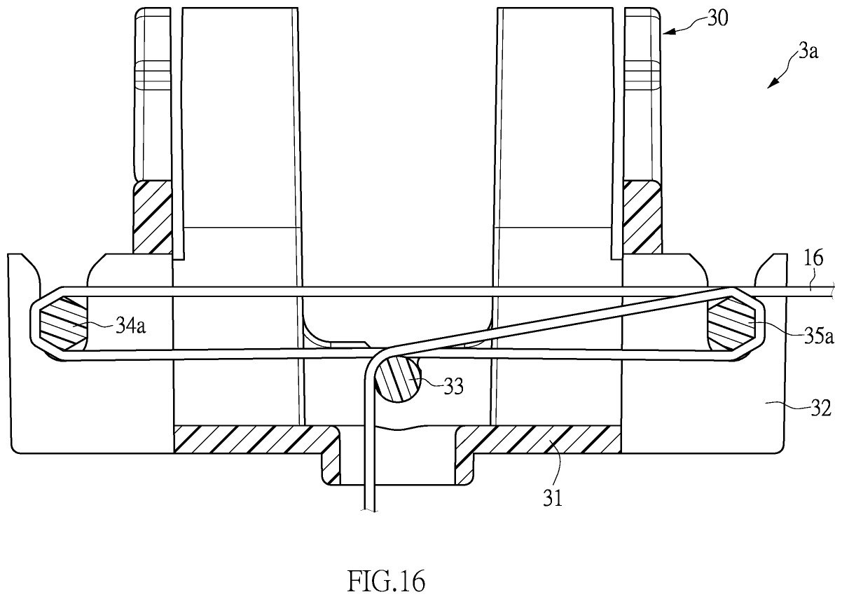

As shown in FIG. 16, a positioning device 3a is provided with a first side overbend element 34a, a second side overbend element 35a and a middle overbend element 33. The cross section of the first side overbend element 34a and the cross section of the second side overbend element 35a are in a shape of hexagon, with sides being intersected with six ridges in a shape of blunt angle (same as the ridges 302 described in FIG. 2).

In the present embodiment, the wiring method in FIG. 16 is similar to that in FIG. 14.

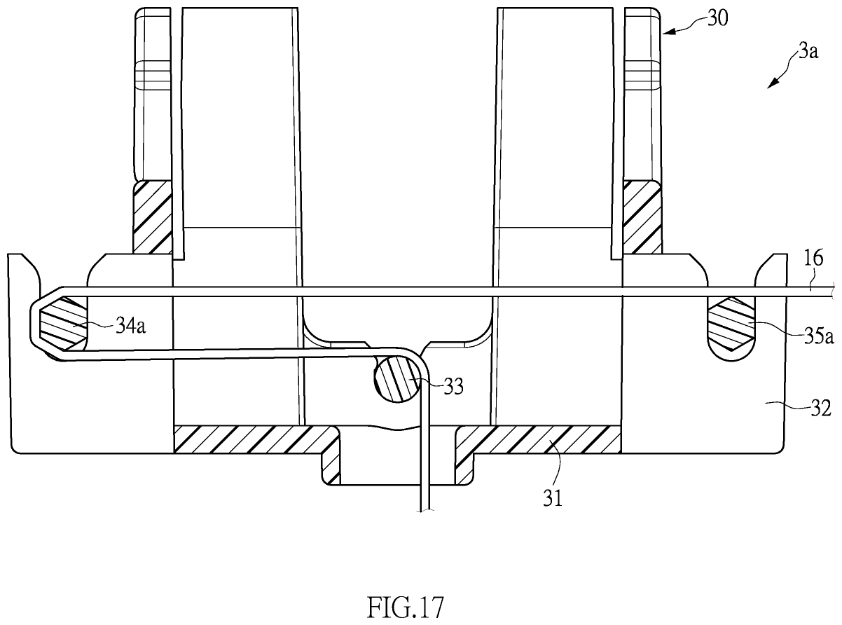

As shown in FIG. 17, three overbend elements are the same as the implemented structures in FIG. 16, with the only difference being the wiring method. The pull cord 16 first passes through an upper side of the second side overbend element 35a of the positioning device 3a, and then turns back by 180° from top to bottom and wraps around the first side overbend element 34a. Next, the pull cord 16 wraps around the middle overbend element 33 again, turns back by 90° from top to bottom and passes through the middle overbend element 33, followed by penetrating the slat 18 (not shown in the drawing) downward.

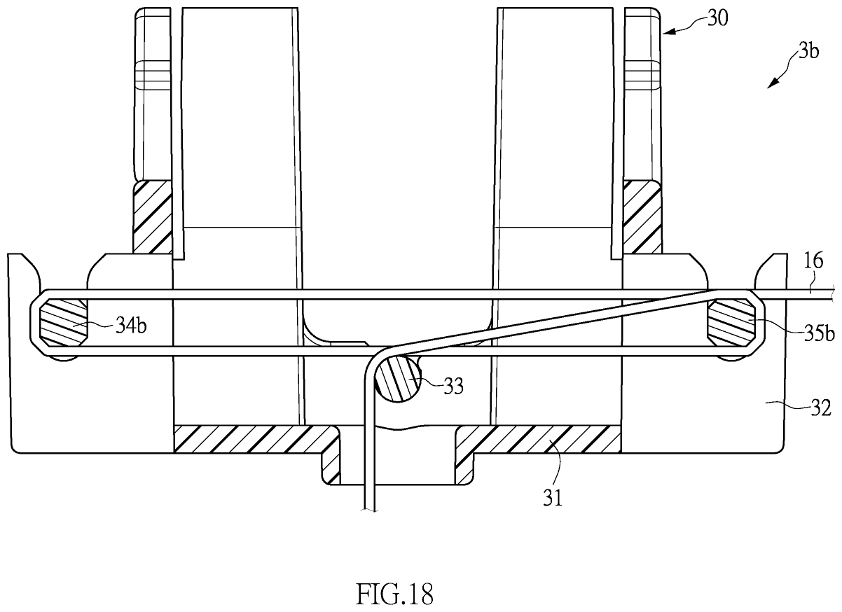

As shown in FIG. 18, in the present embodiment, the cross sections of the first side overbend element 34b and the second side overbend element 35b of the positioning device 3b are in a shape of tetragon, with the straight corners being provided with the ridges 302 as in FIG. 2. Or, each straight corner can be processed into an inverted angle to form an octagon cross section.

In the present embodiment, FIG. 18 shows a kind of wiring method for the pull cord 16 to pass through the positioning device 3b, similar to the example in FIG. 16. The pull cord 16 wraps around an upper left plane, an upper left slope, a left side, a lower left slope and a lower left plane of the first side overbend element 34b. The friction force between the pull cord 16 and the first side overbend element 34b is larger than that provided by a normal rod due to the change in shape of the structures.

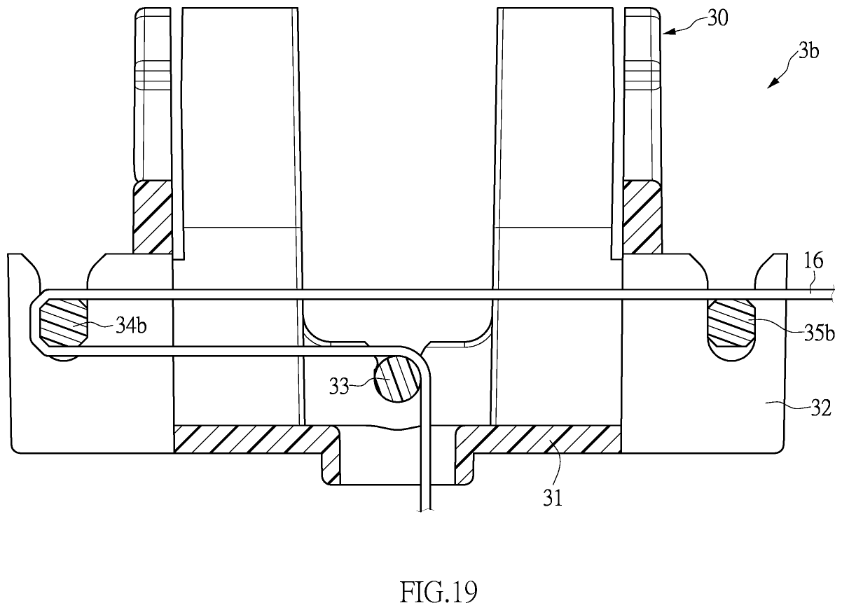

As shown in FIG. 19, the wiring method is that the pull cord 16 first passes through an upper side of the second side overbend element 35b of the positioning device 3b, turns back by 180° from top to bottom and wraps around the first side overbend element 34b, and then wraps around the middle overbend element 33 again to turn back by 90° from top to bottom, followed by penetrating the slat 18 (not shown in the drawing) downward.

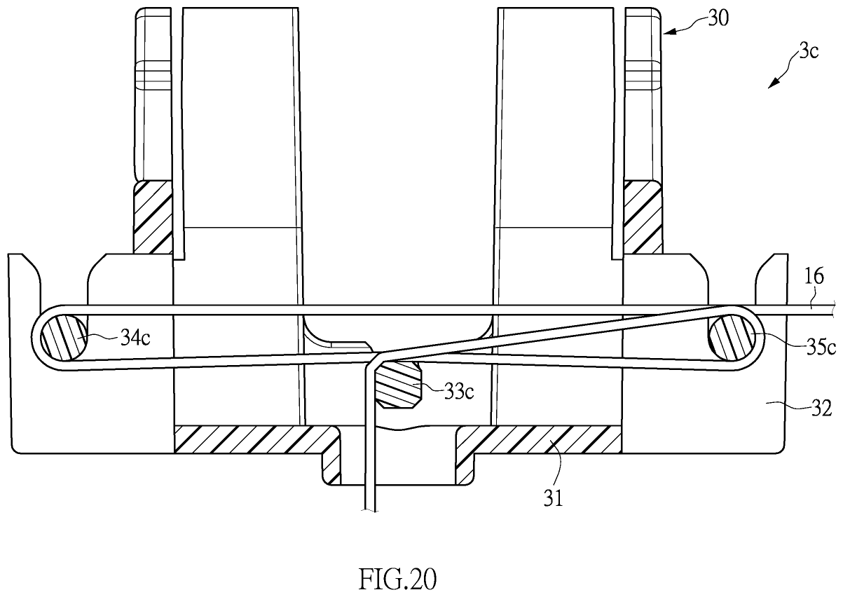

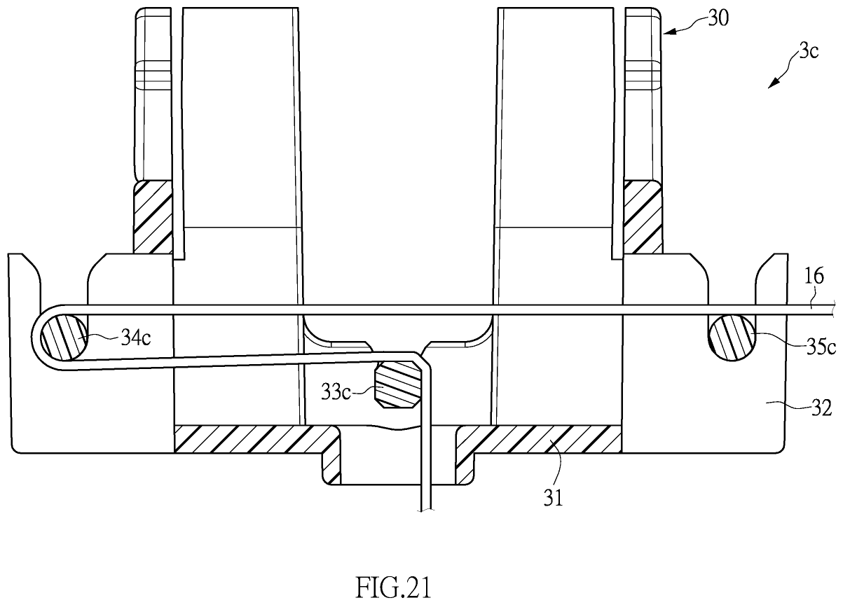

As shown in FIG. 20, in the present embodiment, the cross section of the middle overbend element 33c of the positioning device 3c is not in a shape of circle, but in a shape of tetragon. In addition, each corner is formed with an inverted angle. In other words, the cross section is roughly in a shape of octagon. However, the cross section of the middle overbend element 33c can be also in a shape of non-circle, similar to other embodiments. In the present embodiment, the cross section of the first side overbend element 34c or second side overbend element 35c can be in a shape of circle, and the first side overbend element 34c or second side overbend element 35c can be fixed on the turning seat 30 with a tight-fitting method.

The wiring method in FIG. 20 is similar to that in FIG. 14. The friction force between the pull cord 16 and the middle overbend element 33c is larger than that provided by an ordinary rod.

As shown in FIG. 21, it shows another kind of wiring method that the pull cord 16 passes through the positioning device 3c. Three overbend elements in FIG. 21 are the same as the implemented structures in FIG. 20, with the only difference being the wiring method. The pull cord 16 first passes through an upper side of the second side overbend element 35c of the positioning device 3c, and then turns back by 180° from top to bottom and wraps around the first side overbend element 34c. Next, the pull cord 16 wraps around the middle overbend element 33c again, and turns back by 90° from top to bottom and passes through the middle overbend element 33c, followed by penetrating the slat 18 (not shown in the drawing) downward.

In the present invention, by the technical solution that the cross section of the ridge provided by the overbend element is noncircular, the effect of locking the slat at a fixed point in the pull-down height can be improved, which effectively prevents the bottom rail from sliding downward by a natural external force or gravity itself.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A blind slat positioning device, comprising
a turning seat, which provides for a pull cord to turn and cross over, with the pull cord being formed by twisting fibers, and the cross section of a thread body varying in shape, with a bottom of the turning seat including a base plate, and an overbend element in a shape of long rod for the thread of pull cord to climb over and change direction, with the overbend element being combined inside the turning seat, and a longitudinal line of the overbend element being parallel to the base plate and transversely perpendicular to a running direction of the pull cord, and with the overbend element further including
a rod body, two ends of which being fixed at a three-dimensional angle; and
a long ridge, which is disposed on a longitudinal surface of the rod body, and is disposed on a longitudinal location at which the overbend section of the thread of pull cord passes through tangentially.

2. The blind slat positioning device according to claim 1, wherein the ridge is disposed on a middle angle in an overbend section of the thread of pull cord.

3. The blind slat positioning device according to claim 1, wherein there are more than two ridges, which are disposed on an equal angle in an overbend section of the thread of pull cord.

4. The blind slat positioning device according to claim 1, wherein a tip of the ridge is in a shape of arc.

5. The blind slat positioning device according to claim 1, wherein the overbend element is formed by a rod, an outer surface of the rod is provided with the ridge, and a total cross section thereof is in a shape of triangle.

6. The blind slat positioning device according to claim 1, wherein the overbend element is formed by a rod, an outer surface of the rod is provided with the ridge, and a total cross section thereof is in a shape of rhomboid.

7. The blind slat positioning device according to claim 1, wherein the overbend element is formed by a rod, an outer surface of the rod is provided with the ridge, and a total cross section thereof is in a shape of T.

8. The blind slat positioning device according to claim 1, wherein the overbend element is formed by a rod, an outer surface of the rod is provided with the ridge, and a total cross section thereof is in a shape of cross.

9. The blind slat positioning device according to claim 1, wherein the overbend element is formed by a rod, an outer surface of the rod is provided with the ridge, and a total cross section thereof is in a shape of square.

10. The blind slat positioning device according to claim 1, wherein the overbend element is formed by a rod, an outer surface of the rod is provided with the ridge, and a total cross section thereof is in a shape of U.

11. The blind slat positioning device according to claim 1, wherein the overbend element is formed by a rod, an outer surface of the rod is provided with the ridge, and a total cross section thereof is in a shape of hexagon in blunt angles.

12. The blind slat positioning device according to claim 1, wherein the overbend element is formed by a rod, an outer surface of the rod is provided with the ridge, and a total cross section thereof is in a shape of polygon in blunt angles.

13. The blind slat positioning device according to claim 1, wherein the turning seat further includes a base plate, a bottom of the base plate is transfixed with a downward perforation for the pull cord to cross over, and two sides of the base plate are provided upward with opposite embedding parts for combining two ends of the overbend element.

14. The blind slat positioning device according to claim 13, wherein there are three embedding parts which are distributed at corners of a virtual triangular region, the triangle is put on the base plate upside-down, and the embedding part at a center is positioned above the downward perforation.

15. The blind slat positioning device according to claim 14, wherein the center embedding part provides for embedding an overbend element in a circular cross section.

16. The blind slat positioning device according to claim 1, further comprising:
a top rail, an interior of which is provided with a longitudinal groove;
a slat, which is combined flat at a lower side of the top rail;
a release mechanism which is disposed in a center of the groove, with two sides of the release mechanism linking outward a pull cord along the groove;
two sets of positioning devices, with each positioning device being positioned on a side of the top rail to provide for the thread of each pull cord to turn and cross over downwardly, and the thread of pulled down pull cord penetrating the slat; and
a bottom rail, an upper side of which provides for combing with a lower side of the slat, with two sides of the bottom rail being used to fix and connect a free end of the pull cord respectively.
